(19) United States
(12) Patent Application Publication
(10) Pub. No.: US 2015/0185750 A1
(43) Pub. Date: Jul. 2, 2015

(54) Method and Apparatus for monitoring an energy feed-in point of an energy supply grid

(71) Applicants: Stefan Langemeyer, Nurnberg (DE); Johannes Reinschke, Nurnberg (DE)

(72) Inventors: Stefan Langemeyer, Nurnberg (DE); Johannes Reinschke, Nurnberg (DE)

(21) Appl. No.: 14/412,343

(22) PCT Filed: Jul. 5, 2012
(86) PCT No.: PCT/EP2012/063184

§ 371 Date: Dec. 31, 2014

(51) Int. Cl. G05F 1/66; G05B 15/02

(52) U.S. Cl. CPC G05F 1/66; G05B 15/02

(57) ABSTRACT

A method for monitoring an energy feed-in point of an energy supply network is particularly suited for low voltage systems. A number of first and second nodes a producer, consumer, or prosumer—are connected to the feed-in point. An actual current representing the current consumption or current output is detected at the feed-in point by a measuring and monitoring device. An item of current information received from a first node, representing an intended and/or maximum possible current consumption or output of the first node, is processed by checking whether a current value thereof fulfills a predetermined criterion relative to a possible current value of the feed-in point. The possible current value is a differential between the predetermined maximum current and the actual current. Depending on whether the criterion is fulfilled, a message is transmitted confirming or denying the current consumption or output to the first node.

The invention relates to a method and an apparatus for monitoring an energy feed-in point of an energy supply grid, in particular in the low-voltage range. A number of first and second nodes is connected or connectable to the energy feed-in point, wherein a respective node is an energy producer, an energy consumer or a prosumer.

In the present description, first nodes are nodes which have communication means and which can communicate with an apparatus implementing the method. Second nodes are nodes which do not have communication means and therefore cannot perform a communication with the apparatus implementing the method.

A prosumer is understood to mean a component which is both capable of producing energy and feeding it into the energy supply grid and capable of consuming energy and drawing energy from the energy supply grid. An example of this is, for example, electrically operated motor vehicles, which can draw energy from the energy supply grid for charging their batteries or can feed energy from their stores into the energy supply grid during peak-load hours.

A plurality of electrical loads or sources can be connected to the energy supply grid via a (central) energy feed-in point. Loads and sources are nodes within the meaning of the invention. For example, a plurality of charging stations for electric vehicles and/or photovoltaic systems and/or generators can be connected to such an energy feed-in point. Since not all nodes are generally active at the same time with a maximum power consumption or power output, the energy feed-in point of the energy supply grid is often designed such that the summated, maximum possible power consumption or power output (or current consumption or current output) of all of the nodes is greater than the maximum possible or permissible power (or current) at the energy feed-in point. A protective device at the energy feed-in point, for example in the form of a fuse or a contactor, ensures that the maximum permissible power cannot be exceeded at the energy feed-in point. The protective device trips at the latest when a preset maximum current is exceeded and therefore interrupts the electrical connection between the nodes connected to the energy feed-in point and the energy supply grid.

In order to avoid sudden tripping of the protective device, in the simplest case individual nodes which are connected to the energy feed-in point can be configured in such a way that the maximum current consumption or current output of all of the nodes in principle remains below the preset maximum current of the energy feed-in point. In this case, no control is required. However, such a design is unfavorable for cost reasons.

It is likewise possible to provide communication between a monitoring device at the energy feed-in point and the node connected thereto in order to control power flow. Such a procedure has proven to be difficult when the nodes and/or the monitoring apparatus are in the sphere of different operators at the energy feed-in point. In this case, frictionless communication needs to be ensured in order to avoid an overload case owing to the communication performed between the monitoring apparatus and the node.

The object of the present invention consists in specifying a method and an apparatus for monitoring an energy feed-in point of an energy supply grid with which an overload case at the energy feed-in point can be avoided with a high degree of reliability, wherein, at the same time, the system is intended to be capable of being operated as close as possible to the preset maximum current of the energy feed-in point, however.

This object is achieved by a method in accordance with the features of patent claim 1 and an apparatus in accordance with the features of patent claim 14. Advantageous configurations result from the dependent patent claims.

The invention provides a method for monitoring an energy feed-in point of an energy supply grid, wherein a number of first and second nodes is connected or connectable to the energy feed-in point, wherein a respective node is an energy producer, an energy consumer or a prosumer. In particular, the energy supply grid is an energy supply grid in the low-voltage range. The voltages for a single-phase and three-phase grid are different from country to country. In Germany, the voltage is 230 V in the case of a single-phase grid and 400 V in the case of a three-phase grid. In other countries, other voltage values are sometimes selected.

In the method, the following steps are performed:
a) An actual current which is representative of the current consumption or current output is detected at the energy feed-in point by a measuring and monitoring device.
b) An item of current information which is obtained from one of the first nodes and represents an intentional and/or a maximum possible current consumption or current output of the first node is processed by virtue of a check being performed to ascertain whether a current value of the item of current information meets a preset criterion in respect of a possible current value of the energy feed-in point.
c) The possible current value is determined by forming the difference between the preset maximum current of the energy feed-in point and the actual current.
d) Finally, depending on whether the criterion is met or not met, a message which approves or denies the current consumption or output to or from the first node is transmitted to the first node.

The invention furthermore provides an apparatus for monitoring an energy feed-in point of an energy supply grid in particular in the low-voltage range, wherein a number of first and second nodes is connected or connectable to the energy feed-in point, wherein a respective node is an energy producer, an energy consumer or a prosumer. The apparatus comprises a measuring and monitoring device for measuring an actual current representing the current consumption or current output at the energy feed-in point. A communications device is provided for data interchange with the first node. An arithmetic logic unit is used for processing an item of current information which is obtained from one of the first nodes and which represents an intentional and/or a maximum possible current consumption or current output of the first node. In this case, it is possible for a check to be performed by the arithmetic logic unit to ascertain whether a current value of the item of current information meets a preset criterion in respect of a possible current value of the energy feed-in point. In this case, the possible current value is determinable by the arithmetic logic unit by forming the difference between the preset maximum current of the energy feed-in point and the actual current. A message which approves or denies the current consumption or current output to or from the first node is transmittable to the first node by the communications device depending on whether said criterion is met or not met.

The proposed procedure enables dynamic matching of the maximum current/power consumption or output at the energy feed-in point. As a result, the threat of overloads, but also bottlenecks can be identified and avoided preventatively thereby. The procedure makes use of the circumstance that, in future, some of the current consumers and/or suppliers will have the possibility of communicating with an apparatus at the energy feed-in point. In this case, the communication merely serves the purpose of approving or denying the current consumption or current output to or from individual nodes, which wish to connect to the energy feed-in point, depending on the present state using the permanently performed detection by measurement of the actual current. This means that the nodes query at the energy feed-in point whether the current consumption or current output intended by said nodes is possible. On the basis of the actual current provided as a result of measurement, the energy feed-in point decides whether the requesting node can be electrically connected to the energy feed-in point or not.

Instead of a current consideration, it is also possible for there to be a power consideration. Where the description below discusses processing of a current, it would likewise be possible for the power to be considered instead.

In contrast to the technically more complex solutions known from the prior art, there is no control of individual nodes by the energy feed-in point or the apparatus monitoring the energy feed-in point in this case. The nodes only obtain an item of information in respect of whether and possibly to what degree they can draw or output current. The extent to which the nodes implement this information is not influenced by the method or the apparatus. As a result, only a small amount of data interchange between the apparatus and the requesting node is required. This makes it possible in particular even for those components which come from different manufacturers or are located in the sphere of different operators to communicate with one another. Complex, proprietary communications protocols can be dispensed with in this case.

The procedure ensures that no overload case can occur, at least owing to the first nodes. At the same time, however, it is possible to get closer to the loading limits of the energy feed-in point and at the same time to reduce the number of grid disconnections owing to overload.

As can be seen better from the further description, in addition also those nodes which cannot be involved in the communication with the apparatus can be connected to the energy feed-in point. The consideration of the energy drawn or supplied by these second nodes from or to the energy feed-in point is performed implicitly by the measurement of the actual current, on the one hand, and the knowledge of the first nodes connected to the energy feed-in point and the maximum current withdrawal or output thereof known as a result of the preceding communication, on the other hand.

In an expedient configuration, the criterion is met when the current value of the item of current information is less than the magnitude of the possible current value. If the first node wishes to draw current from the energy feed-in point, said node emits, by means of the item of current information, a current value that it wishes to draw. If this current value is less than a difference value determined from the difference between the preset maximum current and the actual current, the first node can be electrically connected to the energy feed-in point without an overload case occurring.

On the other hand, the criterion is not met when the current value of the item of current information is greater than the magnitude of the possible current value. In this case, the energy feed-in point is already being operated close to or at its loading limit. The difference value between the preset maximum current and the measured actual current is already so low that if any further current were to be drawn, as transmitted by the current value of the item of current information, this would exceed the maximum current at the energy feed-in point after electrical connection. This would result in an undesired overload case.

Steps a) to d) described above are expediently performed separately for each first node wishing to consume or output current. As a result, the apparatus of the energy feed-in point which implements the method can decide for each first node whether said first node can be connected to the energy feed-in point or not. As a result, the communication between the first node and the apparatus can be restricted to the interchange of only two messages (a request from the first node and a response from the apparatus to the first node). Furthermore, the dynamics of the withdrawal of current or the output of current can be kept at a low level owing to the apparatus monitoring the energy feed-in point.

In order to be able to respond in the event of the threat of an overload to individual first nodes decidedly in order to reduce the current consumption or current output of said first nodes, provision is made for the item of current information to be stored together with an identifier for the first node. This can take place, for example, in a local memory of the apparatus implementing the method. Alternatively, a central memory of the energy supply grid could likewise be used, wherein in this case the mentioned items of information need to be transmitted to a central arithmetic logic unit of the central memory.

The item of current information comprises either a current value measured by the first node or a current value stored in the first node or an item of information representing the current value, wherein, in the latter case, an arithmetic logic unit of the energy feed-in point can draw a conclusion on the current value from the item of information. Such an item of information could be, for example, a type designation of the node, which is linked directly to a connected load. For example, a database can be provided for this purpose, in which the connected loads of components of different manufacturers are stored. A corresponding item of information can then be used to determine the current value which generally arises during operation.

In the message which approves or denies the current consumption or output to or from the first node, a maximum permitted level of current consumption or current output is transmitted, wherein the maximum permitted level is less than or equal to the current value contained in the item of current information. This configuration makes it possible for a requested current value to be approved or denied for the apparatus implementing the method not only with simply “yes” or “no”, but also for a current level deviating from that in the request from the first node to be transmitted as maximum permissible current value. If, for example, the first node requests that a current of the order of 50 A is drawn, a current value of the order of 25 A can be transmitted to the first node by the apparatus as maximum permissible current. The first node can then itself decide whether it wishes to perform the withdrawal of current of the order of 25 A or not. Likewise, a factor can be transmitted as the response. For example, “0.6” or “1.3” in response to the requested current of the order of 50 A means that 30 A (i.e. 0.6 times) or 65 A (i.e. 1.3 times) can be transmitted.

Provision is furthermore made for an electrical connection of the energy feed-in point to the energy supply grid to be interrupted when the measured actual current reaches or exceeds the maximum current. This may be the case, for example, when an excessively high number of second nodes which do not communicate with the apparatus implementing the method in respect of a current consumption or current output, is connected to the energy feed-in point.

Likewise, an overload case may occur when, in accordance with a further configuration, a message for reducing or ending the current consumption or current output is transmitted to individual or all of the first nodes when the actual current has reached a current threshold value, which is less than or at most equal to the preset maximum current. Since the first node can automatically decide upon such a message whether it reduces or ends the current consumption or current output, it is possible for the mentioned overload case to arise if the request is not taken into consideration.

In one configuration, provision may be made for the above message for reducing or ending the current consumption or current output to be transmitted to the first nodes as a broadcast message. In contrast, the communication as to whether a node can be connected to the energy feed-in point for the purpose of current consumption or current output takes place individually.

In accordance with a further configuration, a check is performed to ascertain whether, over the course of time, there is an in particular approximately constant discrepancy between the current value obtained from the item of current information and an actual current value measured by the arithmetic logic unit when, after the message which approves or denies the current consumption or current output to or from the first node, the first node consumes or outputs current corresponding to the preset in the message, wherein the arithmetic logic unit replaces the item of current information assigned to the first node with an item of current information which is corrected corresponding to the actual current value determined by the arithmetic logic unit in the event of a discrepancy being established which is above a preset limit. Such discrepancies can occur, for example, as a result of the dynamics of the operation of the first node. Likewise, such discrepancies can also be dependent on efficiency, however. If the first node can only be operated with substantially poorer efficiency, for example owing to external circumstances, for example, the actual current consumption or current output can deviate from the previously agreed current value. With such a discrepancy, the apparatus implementing the method is monitored and documented in a memory in order to have a precise available “residual current quantity” for further first nodes.

A conclusion is drawn in respect of the current consumption or current output of the entirety of the second nodes, which are not capable of transmitting messages or receiving messages, from the difference between the actual current and the sum of the items of current information of the first nodes, which consume or output current. As a result, the statistically fluctuating current values of the second nodes can be determined. The maximum current value which can be released for the sum of all first nodes can be determined from the statistics of the fluctuating current value and the measured actual current value of all second nodes. The current values of all of the second nodes can be determined from the difference between the actual current value and the current values for all of the registered first nodes stored in the memory.

Provision can furthermore be made for the maximum current of the energy feed-in point to be preset by a superordinate unit of the energy supply grid.

The apparatus according to the invention has, by virtue of the components mentioned at the outset, a protective device which can be used to interrupt the electrical connection to the energy supply grid when the actual current measured by the measuring device reaches or exceeds the maximum current.

Furthermore, the apparatus has further means for implementing the above-described method.

The invention will be explained in more detail below with reference to an exemplary embodiment in the drawing, in which:

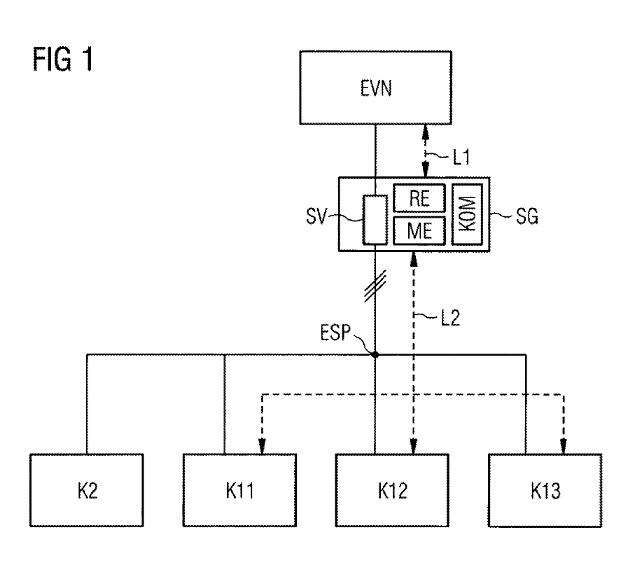

FIG. 1 shows a schematic illustration of an apparatus according to the invention for monitoring an energy feed-in point of an energy supply grid, to which a plurality of nodes is connected, and

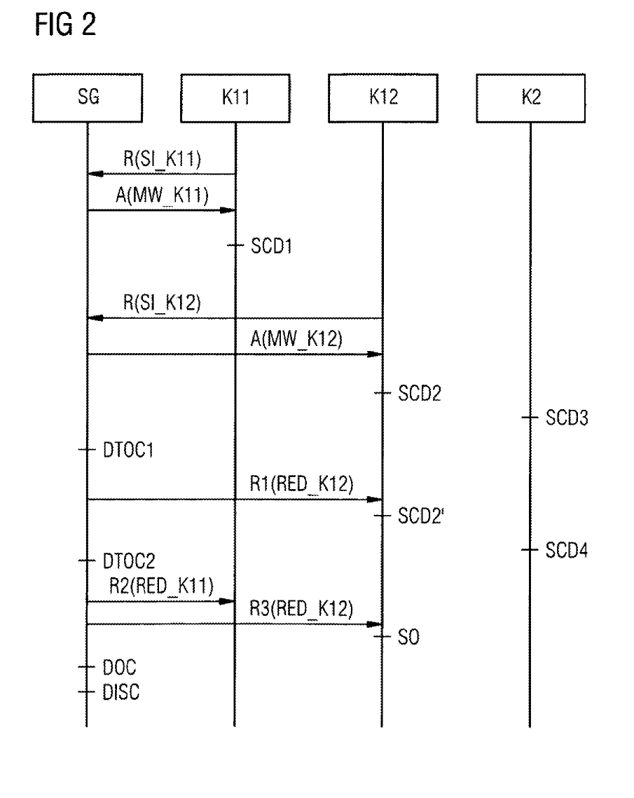

FIG. 2 shows a flowchart illustrating the procedure of the method according to the invention.

FIG. 1 shows a schematic illustration of an apparatus according to the invention for monitoring an energy feed-in point ESP of an energy supply grid EVN. The apparatus comprises a protective apparatus SG, which can be considered to be a combination of a power monitoring device and a protective switch. The protective apparatus SG is arranged between the energy feed-in point ESP and the energy supply grid EVN. The line between the protective apparatus SG and the energy feed-in point ESP is three-phase, merely by way of example, as a result of which a voltage of 400 V, for example, is supplied to nodes K11, K12, K13 and K2 connected to the energy feed-in point ESP. Likewise, the lines connecting the nodes K11, K12, K13, K2 to the protective apparatus SG could be single-phase lines. In this case, a supply voltage of 230 V would be supplied to the nodes K11, K12, K13, K2, for example. The mentioned voltage values apply to an energy supply grid in the low-voltage range in Germany. In other countries, the voltages of a three-phase and a single-phase energy supply grid are sometimes selected differently in a manner which is known to a person skilled in the art.

The protective apparatus SG comprises a protective switch SV, a communications device KOM, a measuring device ME and an arithmetic logic unit RE. Where the present description discusses a protective switch SV, this can be understood to mean a controlled switch, but also a fuse or a contactor. In general, possible protective switches are those components which interrupt the electrical connection between the energy feed-in point and the energy supply grid EVN in the event of a current flowing via the protective switch SV which exceeds a preset maximum current.

The object of the measuring unit ME consists in detecting the current flowing via the protective switch SV (actual current). This corresponds to the current flowing at the energy feed-in point as a result of current consumption or current output of the nodes K11, K12, K13, K2. If the actual current exceeds the preset maximum current, the protective switch SV is either automatically tripped or, controlled by the arithmetic logic unit RE, interrupts the connection between the energy supply grid EVN and the energy feed-in point ESP.

The communications device KOM is designed to communicate with first nodes K11, K12, K13. The first nodes have corresponding communication means (not illustrated). In contrast, the node K2 comprises, for example, a second node which has no communication means and therefore also cannot implement the communication described below. The second node K2 could also be designed in such a way that, although it has communication means, these communication means are not suitable for communicating with the communications device KOM of the protective apparatus SG.

The communication between the protective apparatus SG and the first node K11, K12, K13 can be either line-based or wireless. The communications channel is identified by L2 schematically in the figure.

Advantageously, the communication between the protective apparatus SG and the first node K11, K12, K13 is based on a public standard, such as, for example, powerline communication (PLC), WiFi or ZigBee. Preferably, communication takes place via PLC, in which case the electrical lines can be used for transmitting data signals.

The use of a public standard is expedient since the protective apparatus SG, on the one hand, and the first nodes K11, K12, K13 connected thereto, on the other hand, can belong to different owners or operators, can be of different types or can be provided by different manufacturers. Typically, the protective apparatus SG is operated by the operator of the energy supply grid EVN or falls under the control of said operator. The first nodes K11, K12, K13 which communicate with the protective device via the communications channel L2, on the other hand, are often in the hands of customers of the operator of the energy supply grid EVN.

The first nodes K11, K12, K13 and the second node K2 are, for example, either energy producers (for example a photovoltaic system), energy consumers (for example a battery to be charged of an electric vehicle) or a so-called prosumer. A prosumer is a component which can consume energy but can also produce energy and feed it into the energy supply grid. For example, the battery of an electrically operated vehicle can also be used as a source, for example for reducing short-term load peaks.

The protective apparatus SG can furthermore optionally communicate with a control center (not illustrated) of the energy supply grid EVN via a schematically indicated communications channel L1, which may be line-based or wireless. The preset maximum current flowing via the energy feed-in point ESP can be preset or changed, for example, via this communications channel L1.

The arithmetic logic unit RE processes the actual current detected by the measuring device ME and the items of information which are interchanged as part of a communication.

The sequence of the method for monitoring the energy feed-in point ESP will be explained in more detail below with reference to FIG. 2. The procedure assumes that the first nodes K11, K12, K13, which have communication means for data interchange with the communications device KOM of the protective apparatus SG, query at the protective apparatus SG how much current they can or are permitted to transmit at least prior to activation of said nodes, i.e. prior to the consumption or output of current.

In the sequence illustrated in FIG. 2, by way of example the first nodes K11 and K12 and the second node K2 are illustrated in addition to the protective apparatus SG. The sequence of the communication is from top to bottom in chronological order in FIG. 2. The first node K11, an energy consumer, wishes to draw a current of 50 A, for example. The current value of 50 A mentioned by way of example is transmitted as an item of current information SI in a message R(SI_K11) to the protective apparatus SG. The current value can in this case correspond to a rated or maximum current value of the node K11. Likewise, the current value which is transmitted in the message R(SI_K11) to the protective apparatus SG can be lower than the rated or maximum current value, for example because the operation of the first node K11 can or is intended to be performed at this lower current.

The protective apparatus SG (i.e. the arithmetic logic unit RE thereof) now performs a check to ascertain whether the current value transmitted in the message R(SI_K11) can be released to the first node K11. For this purpose, first the difference is formed between the preset maximum current, for example 1000 A, of the energy feed-in point ESP and the measured actual current at the present point in time. For example, the actual current is at present 800 A, with the result that it is possible for current of 200 A to be drawn until the onset of an overload case. The enabling of the current consumption by the first node K11 can take place without the overload case occurring since the possible current (200 A) is greater than the requested current value (50 A). Therefore, the requested current of 50 A is released in a response A(MW_K11) of the protective apparatus SG to the first node K11. This can take place in the simplest variant by virtue of an item of binary information, which corresponds to a “yes” or a “no”. Likewise, the maximum current which can be drawn by the requesting first node K11 can be transmitted, in this case 50 A. Owing to the positive approval, a current consumption is set by the first node K11, SCD1. At the same time, the protective apparatus SG stores the current value which is requested by the first node K11 or is enabled by the protective apparatus (50 A) in conjunction with an identifier of the first node K11.

In the further course of proceedings, the above-described operation likewise takes place by means of the first node K12 which wishes to draw current of 100 A, for example. The current value is transmitted as an item of current information SI of the first node K12 in the message R(SI_K12) to the protective apparatus SG. Corresponding to the above-described check, a residual current quantity of 150 A remains until the onset of the overload case. Since the requested current level is less than the difference between the maximum current and the actual current, the request from the first node K12 can be granted. The protective apparatus SG therefore transmits the current value MW=100 A as possible current in a message A(MW_K12). At the same time, the protective apparatus SG stores the current value requested by the first node K12 or enabled by the protective apparatus (100 A) in conjunction with an identifier of the first node K12. Then, the first node K12 sets a current consumption of 100 A.

Instead of the transmission of a current value in the item of current information, it would likewise be possible for an item of information representing the current value to be transmitted by the requesting first node K11, K12 to the protective apparatus SG. For example, a manufacturer identification and type identification of the first node K11, K12 could be transmitted in the item of current information. An assignment of this item of information to a requested current value, for example a rated current, could then take place from a table which is stored locally in the protective apparatus SG, for example.

The protective apparatus SG, by analyzing the time profile of the actual current, performs a check to ascertain whether the current values requested by the first nodes K11, K12 are plausible or whether there are discrepancies. In the case of systematic discrepancies, the protective device can replace the item of current information assigned to the node in question with the determined current value. Likewise, correction factors could be used. Specifically, this means that, for example, the first node K12, which has requested a current value of 100 A, actually draws a current of 80 A. As a result, not only 50 A, but 50 A+20 A=70 A actually needs to be available as residual current quantity until the overload case is reached. Although only the current flowing via the energy feed-in point ESP is actually determined by the protective device, an assignment to the individual devices is possible since sequential communication and connection of individual first nodes to the energy feed-in point takes place. For example, the communication or the response to the request from a further first node can only take place when, after a determined waiting period, the difference between a requested current level and the actual current consumption of the node added latterly could be determined.

In the flowchart shown in FIG. 2, the second node K2 then goes to the grid and draws a current of a level which is initially not known to the protective apparatus SG. It is assumed that the second node is a multiplicity of relatively small loads. Said loads are operated randomly. The protective apparatus SG determines the statistically fluctuating current value of all of the second nodes K2 from the difference between the actual current value measured by the protective apparatus SG and the items of current information transmitted by the first nodes. The protective apparatus SG determines the maximum current value that it can release for the sum of all of the communicating loads from the statistics of the fluctuating current value and the present actual current value of all of the second nodes which are not communicating.

For example, the time profile of a fluctuating current value shows that the current value of the second nodes fluctuates at most between ±50 A, in a time interval in which first nodes can be safely disconnected. The current value of the second nodes is at present 100 A, for example. Thus, the protective apparatus can enable a current withdrawal of up to 850 A or an energy recovery of 1050 A.

Using the example of the flowchart shown in FIG. 2, the additional current consumption of the second node K2 results in the threat of an overload being detected, DOTC1. This takes place by the evaluation of the actual current value by the protective apparatus SG. Thereupon, the protective apparatus SG transmits a message R1(RED_K12) in a targeted manner to the first node K12 to reduce the current consumption. Since the first nodes K11, K12, K13 are not controlled or regulated by the protective apparatus, the first node K11 is free to respond to this request or not. In the present exemplary embodiment, the first node K12 reduces the current consumption by setting a new, lower current withdrawal value SCD2′.

Shortly thereafter, the second node K2 increases its current consumption. The protective apparatus SG thereupon registers the threat of an overload again, DTOC2. Shortly thereafter or at the same time, messages R2(RED_K11) and R3(RED_K12) are now transmitted to the first nodes K11, K12 to reduce the current consumption. While the first node K12 responds and is disconnected, SO, the first node K11 does not respond. Once the protective apparatus SG now detects an overload, i.e. a current of more than 1000 A in the present exemplary embodiment, (DOC), disconnection from the grid takes place via the protective switch SV, DISC.

The consideration that relatively large loads, such as, for example, DC quick charging stations, and sources, such as, for example, photovoltaic systems, can only be connected to the energy supply grid EVN when they have the described communication means is associated with the described protective apparatus. The intention here is to prevent charging stations for electric vehicles with a high power consumption going to the grid and immediately tripping the protective switch SV. This is particularly the case when a plurality of charging stations are already active in parallel and the energy feed-in point is loaded with a high current. The same applies in the reverse direction when a plurality of energy producers wish to feed current into the energy supply grid via the same energy feed-in point.

By virtue of the proposed procedure, the maximum current consumption or current output of the energy feed-in point can be matched dynamically. The procedure is advantageous in order that the grid operator can respond preventatively owing to overloads or bottlenecks in superordinate subregions of the energy supply grid.

The protective apparatus can be provided with a data memory. This can be used for the statistical evaluation of the fluctuating current of non-communicating loads, i.e. the second nodes. The memory can be used to store errors or items of information relating to defective nodes. Therefore, a fault analysis can also be realized after disconnection, if appropriate, or a further disconnection once a grid connection has been produced again can be prevented.

The protective apparatus according to the invention makes it possible to get closer to the load limits of the energy distribution grid. Likewise, the number of grid disconnections which are related to overloads can be reduced.

All of the components which are necessary for implementing the method according to the invention can be integrated in the protective apparatus at the energy feed-in point. In this case, implementation with a low level of complexity is possible.

The protective apparatus in this case does not control the nodes directly, but merely provides items of information in respect of the maximum current intensity of a power consumption or power output to said nodes. The connected nodes are automatically controlled on the basis of the items of information received from the protective apparatus.

1-16. (canceled)

17. A method of monitoring an energy feed-in point of an energy supply grid, wherein a plurality of first and second nodes are connected or are connectable to the energy feed-in point, the respective nodes being an energy producer, an energy consumer, or a prosumer, the method comprising:
a) detecting an actual current which is representative of a current consumption or a current output at the energy feed-in point by a measuring and monitoring device;
b) processing an item of current information obtained from one of the first nodes and representing an intended and/or a maximum possible current consumption or current output of the first node by performing a check to ascertain whether a current value of the item of current information meets a preset criterion in respect of a possible current value of the energy feed-in point;
c) determining the possible current value by forming a difference between a preset maximum current of the energy feed-in point and an actual current; and
d) depending on whether the criterion is met or the criterion is not met, transmitting to the first node a message approving or denying the current consumption to, or the current output from, the first node.

18. The method according to claim 17, wherein the criterion is met when a current value of the item of current information is less than a magnitude of the possible current value.

19. The method according to claim 17, wherein the criterion is not met when a current value of the item of current information is greater than a magnitude of the possible current value.

20. The method according to claim 17, which comprises performing steps a) to d) separately for each first node that wishes to consume current or output current.

21. The method according to claim 17, which comprises storing the item of current information together with an identifier of the first node.

22. The method according to claim 17, wherein the item of current information comprises a current value measured by the first node or stored in the first node or an item of information representing a current value, wherein an arithmetic logic unit of the energy feed-in point can draw a conclusion in respect of the current value from the item of information.

23. The method according to claim 17, which comprises transmitting, in the message approving or denying the current consumption or output to or from the first node, a maximum permitted level of current consumption or current output, wherein the maximum permitted level is less than or equal to the current value contained in the item of current information.

24. The method according to claim 17, which comprises interrupting an electrical connection of the energy feed-in point to the energy supply grid when the measured actual current reaches or exceeds the maximum current.

25. The method according to claim 17, which comprises transmitting a message for reducing or ending the current consumption or current output to individual first nodes or to all of the first nodes when the actual current has reached a current threshold value, which is less than the preset maximum current.

26. The method according to claim 25, which comprises transmitting the message as a broadcast message to the first nodes.

27. The method according to claim 17, which comprises:
performing a check to ascertain whether, over a course of time, there exists a discrepancy between the current value obtained from the item of current information and an actual current value measured by an arithmetic logic unit of the energy feed-in point when, after the message that approves or denies the current consumption or current output, the first node consumes or outputs current corresponding to the preset in the message; and
if a discrepancy is established that lies above a preset limit, replacing with the arithmetic logic unit the item of current information assigned to the first node with an item of current information that is corrected corresponding to the actual current value determined by the arithmetic logic unit.

28. The method according to claim 27, which comprises establishing that a discrepancy exists only if the discrepancy is substantially constant.

29. The method according to claim 17, which comprises drawing a conclusion in respect of the current consumption or current output of the entirety of the second nodes, which are not capable of transmitting messages or receiving messages, from the difference between the actual current and the sum of the items of current information of the first nodes, which consume or output current.

30. The method according to claim 17, which comprises setting the maximum current by a superordinate unit of the energy supply grid.

31. The method according to claim 17, configured specifically for a low-voltage energy supply network.

32. An apparatus for monitoring an energy feed-in point of an energy supply grid, wherein a plurality of first and second nodes are connected or are connectable to the energy feed-in point, the first and second nodes being selected from the group consisting of an energy producer, an energy consumer and a prosumer, the apparatus comprising:
a measuring and monitoring device for measuring an actual current representing a current consumption or a current output at the energy feed-in point;
a communications device for data interchange with the first nodes;
an arithmetic logic unit for processing an item of current information obtained from one of the first nodes, the item of current information representing an intended and/or a maximum possible current consumption or current output of the one first node;
said arithmetic logic unit being configured to ascertain whether a current value of the item of current information meets a preset criterion in respect of a possible current value of the energy feed-in point;
said arithmetic logic unit being configured to determine the possible current value by forming a difference between the preset maximum current of the energy feed-in point and the actual current; and
said communications device being configured to transmit to the first node a message approving or denying the current consumption or current output to or from the first node in dependence on whether the criterion is met or not met.

33. The apparatus according to claim 32, further comprising a protective device configured for selectively interrupting an electrical connection to the energy supply grid when the actual current measured by the measuring device reaches or exceeds the maximum current.

34. The apparatus according to claim 32, configured for a low-voltage energy supply network.

35. The apparatus according to claim 32, configured for implementing the method according to claim 17.
